(19) United States
(12) Patent Application Publication
(10) Pub. No.: US 2006/0017738 A1
(43) Pub. Date: Jan. 26, 2006

(54) System and method for detecting memory writes to initiate image data transfers

(76) Inventors: Juraj Bystricky, Richmond (CA); Atousa Soroushi, North Vancouver (CA); Victor Ga-Kui Chan, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/898,082

(22) Filed: Jul. 23, 2004

(51) Int. Cl. G09G 5/36

(52) U.S. Cl. 345/556

(57) ABSTRACT

A system and method for detecting memory writes to initiate image data transfers includes a display controller device with a write detector module and controller logic. The write detector module detects write operations from a host central-processing unit to on-screen data in a video memory of the display controller. The write detector module responsively sets a transfer flag to indicate that the on-screen data has been modified. The controller logic then detects that the transfer flag has been set by the write detector module. The controller logic may then efficiently initiate a frame transfer operation for transferring the modified on-screen data from the video memory to a display of a host electronic device.

### BACKGROUND SECTION

1. Field of Invention

This invention relates generally to electronic display controller systems, and relates more particularly to a system and method for detecting memory writes to initiate image data transfers.

2. Description of the Background Art

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display control operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for detecting memory writes to initiate image data transfers. In certain embodiments, an electronic device may be implemented to include a central-processing unit (CPU), one or more displays, and a display controller. A write detector module of the display controller initially monitors a video memory to determine whether a write operation by the CPU or any other appropriate entity occurs. If the write detector module determines that such a write operation to the video memory occurs, then the write detector module next determines whether the foregoing write operation was to a write address located within moveable on-screen data in the video memory.

If the write detector module determines that the foregoing write operation was to a write address located in the on-screen data of the video memory, then the write detector module responsively sets a transfer flag in controller registers of the display controller to indicate that the on-screen data has been modified. Finally, in response to the foregoing transfer flag, controller logic of the display controller may initiate a corresponding transfer operation to provide a frame of image data from the modified on-screen data of the display controller to a display of the host electronic device. In various embodiments, the foregoing transfer operation may be automatically performed by the controller logic of the display controller, or alternately may be coordinated by the CPU and appropriate system software. The present invention therefore provides an improved system and method for detecting memory writes to initiate efficient image data transfers.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIG. 6 is a block diagram for one embodiment of the on-screen data of FIG. 3, in accordance with the present invention;

FIG. 7 is a block diagram for one embodiment of the on-screen registers of FIG. 4, in accordance with the present invention;

FIG. 8 is a flowchart of method steps for performing transfer operations, in accordance with one embodiment of the present invention; and

FIG. 9 is a flowchart of method steps for performing a write detection procedure, in accordance with one embodiment of the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for detecting memory writes to initiate image data transfers, and includes a display controller device with a write detector module and controller logic. The write detector module detects write operations from a host central-processing unit to on-screen data in a video memory of the display controller. The write detector module responsively sets a transfer flag to indicate that the on-screen data has been modified. The controller logic then detects that the transfer flag has been set by the write detector module. The controller logic may then efficiently initiate a frame transfer operation for transferring the modified on-screen data from the video memory to a display of a host electronic device.

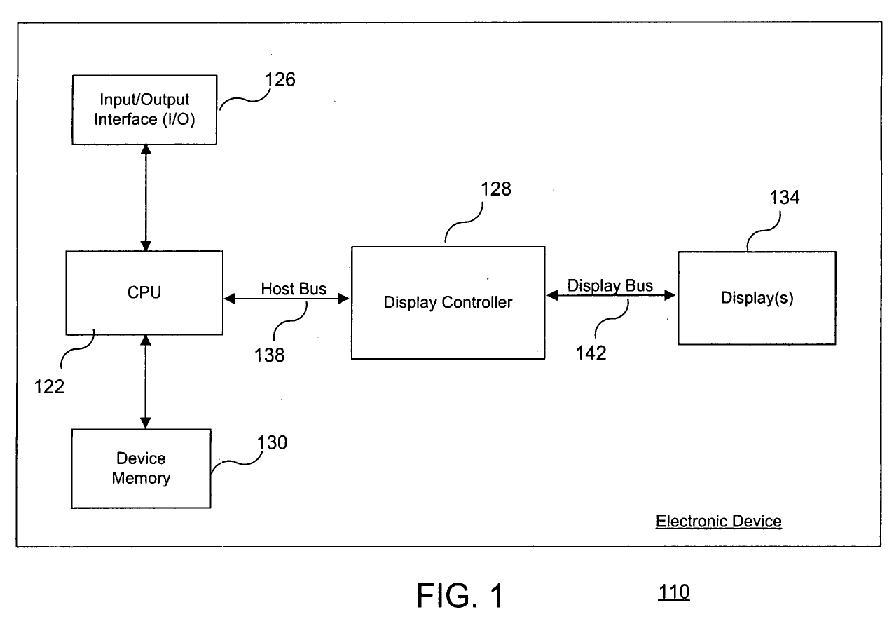

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

In the FIG. 1 embodiment, the foregoing device application may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

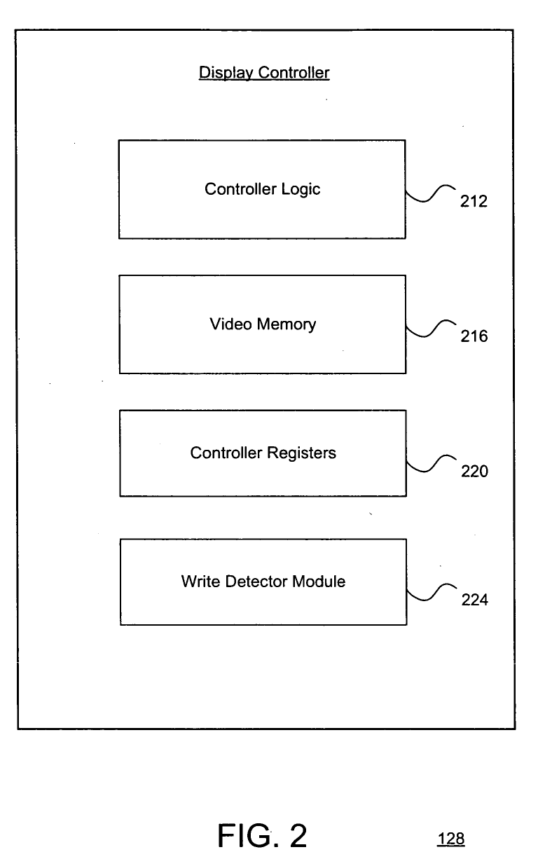

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-9. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, a cellular telephone, or a computer device. Various embodiments for the operation and utilization of electronic device 110 are further discussed below in conjunction with FIGS. 2-9.

Referring now to FIG. 2, a block diagram for one embodiment of the FIG. 1 display controller 128 is shown, according to the present invention. The FIG. 2 embodiment includes, but is not limited to, controller logic 212, video memory 216, controller registers 220, and a write detector module 224. In alternate embodiments, display controller 128 may include elements or functionalities in addition to, or instead of, certain of the elements or functionalities discussed in conjunction with the FIG. 2 embodiment.

In the FIG. 2 embodiment, display controller 128 may be implemented as an integrated circuit device that accepts image data and corresponding transfer and display information from CPU 122 (FIG. 1). Display controller 128 then automatically provides the received image data to display 134 of electronic device 110 in an appropriate and efficient manner for displaying to a device user. In the FIG. 2 embodiment, controller logic 212 manages the overall operation of display controller 128. In certain embodiments, controller logic 212 may include, but is not limited to, an image creation module and a transfer module. The image creation module manages reading image data from video memory 216, and forming corresponding image pixels for display according to information from controller registers 220. The transfer module performs image data transfer operations to provide the foregoing image pixels to display 134 (FIG. 1).

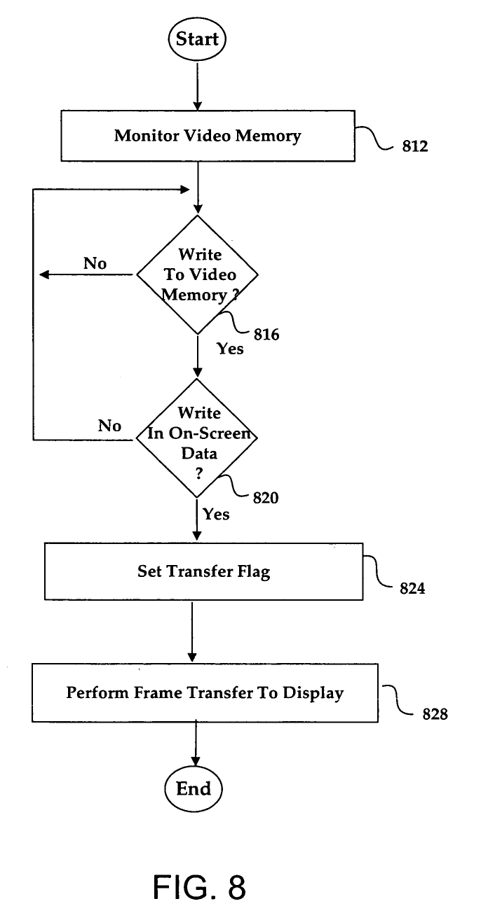

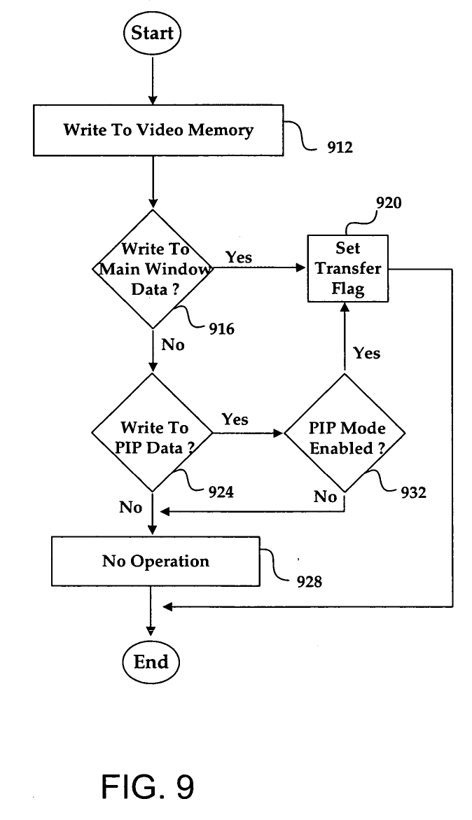

In the FIG. 2 embodiment, display controller 128 may utilize write detector module 224 for detecting write operations that store image data into on-screen data of video memory 216. Detector module 224 may then responsively set a transfer flag for initiating transfer operations from display controller 128 to display 134. Certain embodiments for the implementation and utilization of write detector module 224 are further discussed below in conjunction with FIGS. 8-9.

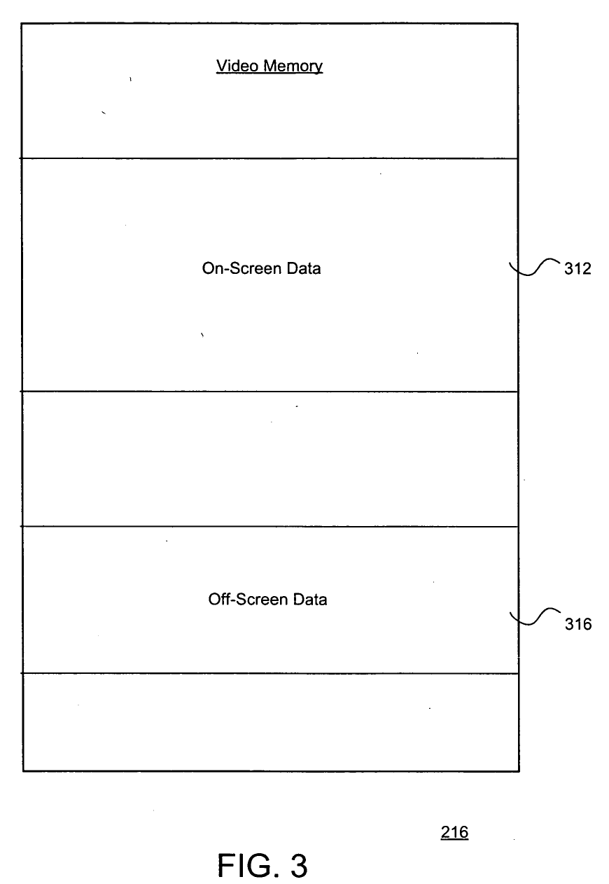

Referring now to FIG. 3, a block diagram for one embodiment of the FIG. 2 video memory 216 is shown, in accordance with the present invention. In the FIG. 3 embodiment, video memory 216 includes, but is not limited to, on-screen data 312 and off-screen data 316. In alternate embodiments, video memory 216 may include elements and functionalities in addition to, or instead of, certain of the elements and functionalities discussed in conjunction with the FIG. 3 embodiment.

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, on-screen data 312 and off-screen data 316 are each shown as single contiguous memory blocks in video memory 216. However, in various other embodiments, different components of on-screen data 312 and/or off-screen data 316 may readily be stored as multiple non-contiguous memory blocks within video memory 216.

In the FIG. 3 embodiment, CPU 122 (FIG. 1) writes image data into on-screen data 312 for transfer by display controller 128 to display 134 of electronic device 110 for viewing by a device user. In the FIG. 3 embodiment, on-screen data 312 includes any appropriate type of information for display upon a screen of display 134 (FIG. 1). For example, on-screen data 312 may include main image data corresponding to a main window area on display 134. In addition, on-screen data 312 may include picture-in-picture (PIP) image data corresponding to one or more picture-in-picture window areas that are positioned within the foregoing main window area on display 134.

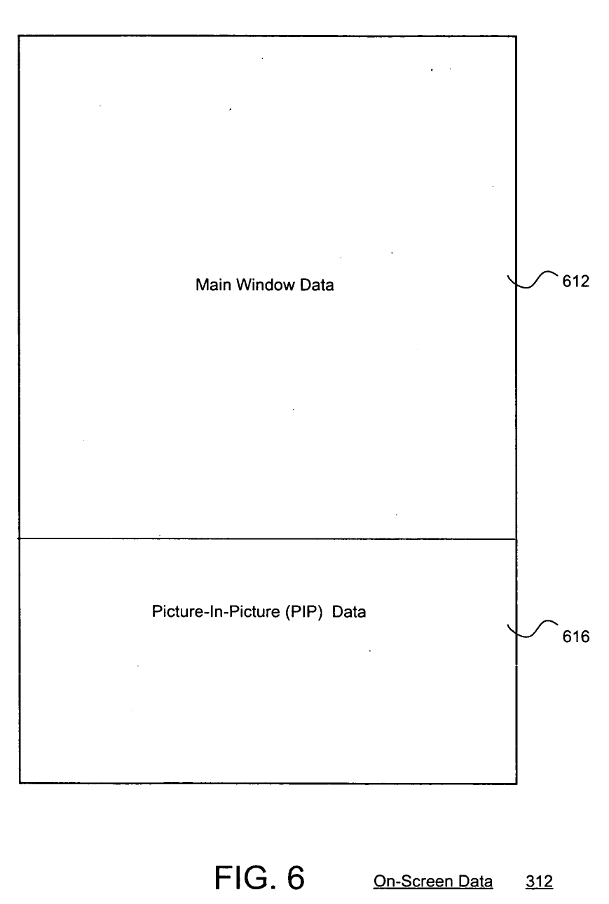

In the FIG. 3 embodiment, off-screen data 316 may include any appropriate type of information or data that is not displayed upon display 134 of electronic device 110. For example, off-screen data 316 may be utilized to support various types of double buffering schemes for display controller 128, or may also be utilized to cache certain fonts or other objects for use by display controller 128. The utilization of video memory 216 is further discussed below in conjunction with FIGS. 6 and 8-9.

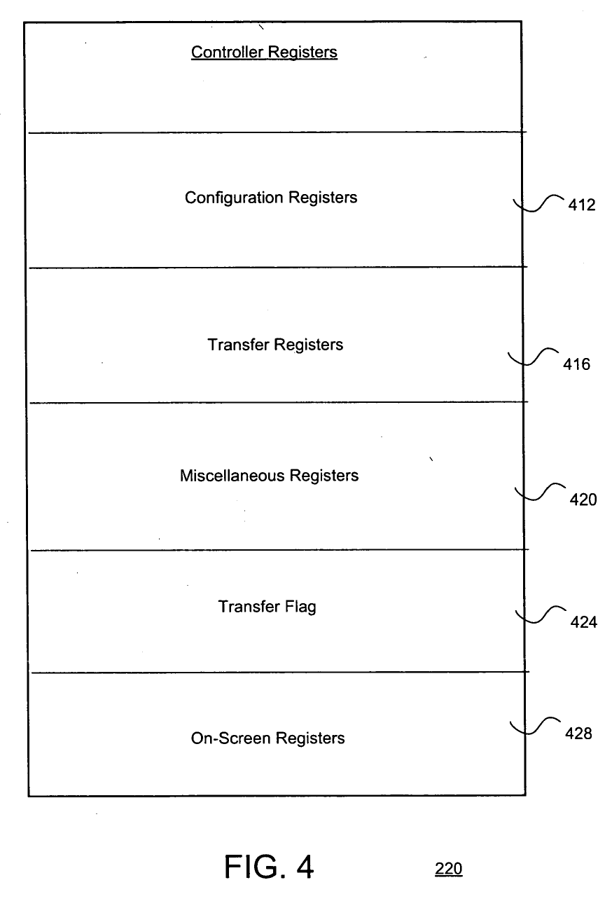

Referring now to FIG. 4, a block diagram for one embodiment of the FIG. 2 controller registers 220 is shown, in accordance with the present invention. In the FIG. 4 embodiment, controller registers 220 include, but are not limited to, configuration registers 412, transfer registers 416, miscellaneous registers 420, a transfer flag 424, and on-screen registers 428. In alternate embodiments, controller registers 220 may include elements and functionalities in addition to, or instead of, certain of the elements and functionalities discussed in conjunction with the FIG. 4 embodiment.

In the FIG. 4 embodiment, CPU 122 (FIG. 1) or other appropriate entities may advantageously write information into controller registers 220 to specify various types of operational parameters and other relevant information for use by configuration logic 212 of display controller 128. In the FIG. 4 embodiment, controller registers 220 may utilize configuration registers 412 for storing various types of information relating to the configuration of display controller 128 and/or display 134 of electronic device 110. For example, configuration registers 220 may specify a display type, a display size, a display frame rate, and various display timing parameters. In the FIG. 4 embodiment, controller registers 220 may utilize transfer registers 416 for storing various types of information relating to transfer operations for providing pixel data from video memory 216 (FIG. 3) to display 134 of electronic device 110.

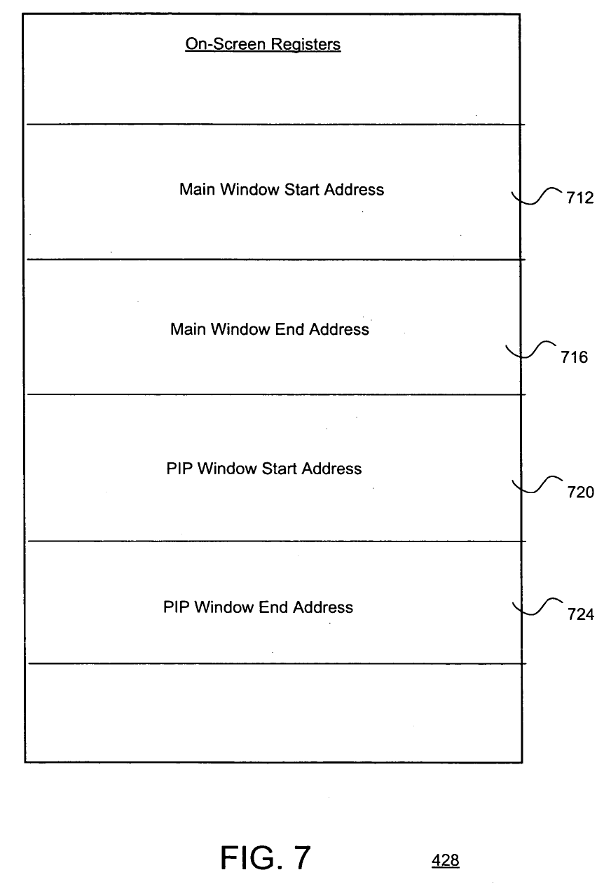

In the FIG. 4 embodiment, controller registers 220 may utilize miscellaneous registers 420 for effectively storing any desired type of information or data for use by display controller 128. In the FIG. 4 embodiment, controller logic 212 (FIG. 2), write detector module 224, or other appropriate entity may set a transfer flag 424 to indicate that certain conditions for triggering a transfer of image data to display 134 have been met. In response, controller logic 212 (FIG. 2) performs a corresponding transfer procedure, as discussed below in conjunction with FIG. 8. In the FIG. 4 embodiment, CPU 122 or other appropriate entity may program on-screen registers 428 to include various types of information regarding specified locations for storing on-screen data 312 in video memory 216. The implementation and utilization of on-screen registers 428 are further discussed below in conjunction with FIGS. 7 and 9.

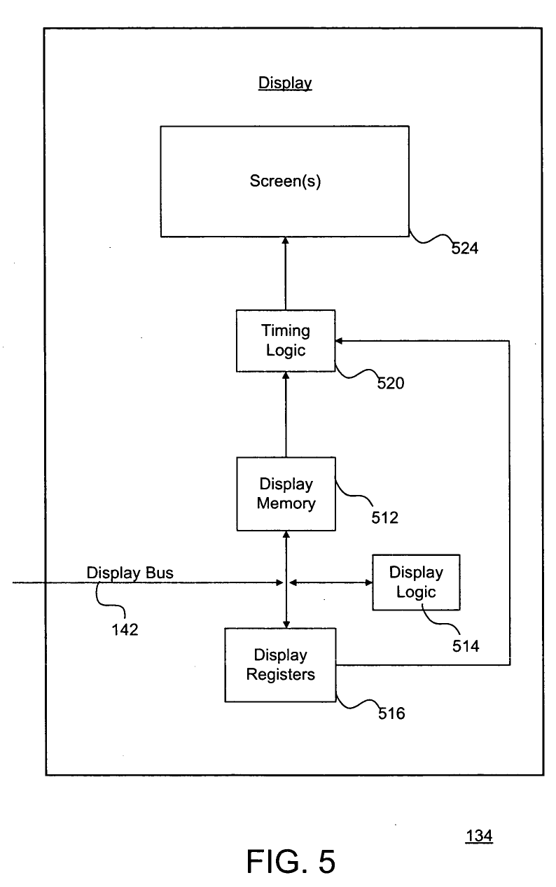

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, controller logic 212 (FIG. 2) of display controller 128 provides image data from video memory 216 (FIG. 2) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 110. Various techniques for efficiently transferring image data to display 134 are further discussed below in conjunction with FIGS. 6 through 9.

Referring now to FIG. 6, a block diagram for one embodiment of the FIG. 3 on-screen data 312 is shown, in accordance with the present invention. In the FIG. 6 embodiment, on-screen data 312 includes, but is not limited to, main window data 612 and picture-in-picture (PIP) data 616. In alternate embodiments, on-screen data 312 may include elements and functionalities in addition to, or instead of, certain of the elements and functionalities discussed in conjunction with the FIG. 6 embodiment. For example, in certain embodiments, electronic device 110 may support more than one PIP window with associated PIP data.

In the FIG. 6 embodiment, on-screen data 312 may include any appropriate type of information for display upon one or more screens 524 of display 134 (FIG. 5). For example, on-screen data 312 may include main window data 612 corresponding to a main window area on display 134. In addition, on-screen data 312 may include picture-in-picture (PIP) data 616 corresponding to one or more picture-in-picture window areas that are positioned within the foregoing main window area on display 134.

In the FIG. 6 embodiment, main window data 612 and PIP data 616 are shown as contiguous memory blocks in on-screen data 312. However, in various other embodiments, main window data 612 and PIP data 616 may readily be stored as non-contiguous memory blocks within video memory 216. The detection of write operations to either main window data 612 or PIP data 616 is further discussed below in conjunction with FIGS. 8-9.

Referring now to FIG. 7, a block diagram for one embodiment of the FIG. 4 on-screen registers 428 is shown, in accordance with the present invention. In the FIG. 7 embodiment, on-screen registers 428 include, but are not limited to, a main window start address 712, a main window end address 716, a PIP window start address 720, and a PIP window end address 724. In alternate embodiments, on-screen registers 428 may include elements and functionalities in addition to, or instead of, certain of the elements and functionalities discussed in conjunction with the FIG. 7 embodiment.

In the FIG. 7 embodiment, CPU 122 or other appropriate entity programs on-screen registers 428 to include starting and ending addresses for currently displayed image data from on-screen data 312 in video memory 216. For example, in the FIG. 7 embodiment, on-screen registers 428 include a main window start address 712 and a main window end address 716 that specify where in video memory 216 the main window data 612 for the foregoing main window area is stored.

Similarly, in the FIG. 7 embodiment, on-screen registers 428 also includes a PIP window start address 720 and a PIP window end address 724 that specify where in video memory 216 the PIP data 616 for the foregoing PIP window area is stored. In accordance with the present invention, write detector module 224 (FIG. 2) may then advantageously compare write addresses from any new write operations to video memory 216 with the foregoing on-screen addresses from on-screen registers 428 to thereby determine whether any pixel information from on-screen data 316 has been altered since an immediately preceding transfer operation has been performed. If write detector module 224 determines that on-screen data 316 has been modified by one or more intervening write operations, then write detector module 224 may set a transfer flag 424 (FIG. 4) to initiate a current transfer operation. The utilization of on-screen registers 428 is further discussed below in conjunction with FIGS. 8-9.

Referring now to FIG. 8, a flowchart of method steps for performing transfer operations is shown, in accordance with one embodiment of the present invention. The FIG. 8 flowchart is presented for purposes of illustration, and in alternate embodiments, the present invention may utilize steps and sequences in addition to, or instead of, certain of the steps and sequences discussed in conjunction with the FIG. 8 embodiment.

In the FIG. 8 embodiment, in step 812, write detector module 224 monitors video memory 216 for write operations by CPU 122 or any other appropriate entity. In step 816, write detector module 224 determines whether a write operation to video memory 216 has occurred. If write detector module 224 determines that such a write operation to video memory 216 has occurred, then in step 820, write detector module 224 determines whether the foregoing write operation was to a write address located in on-screen data 312.

If write detector module 224 determines that the foregoing write operation was to a write address located in on-screen data 312 of video memory 216, then in step 824, write detector module 224 responsively sets a transfer flag 424 in controller registers 220. Finally, in response to the foregoing transfer flag 424, controller logic 212 of display controller 128 may initiate a corresponding transfer operation to provide a frame of image data from on-screen data 312 of display controller 128 to display 134. In various embodiments, the foregoing transfer operation may be automatically performed by controller logic 212 of display controller 128, or alternately may be coordinated by CPU 122 and appropriate system software. The FIG. 8 embodiment therefore provides an improved system and method for detecting memory writes to initiate image data transfers.

Referring now to FIG. 9, a flowchart of method steps for performing a write detection procedure is shown, in accordance with one embodiment of the present invention. The FIG. 9 flowchart presents one embodiment for determining whether a write operation to on-screen data 312 has occurred, as discussed above in conjunction with step 820 of FIG. 8. The FIG. 9 flowchart is presented for purposes of illustration, and in alternate embodiments, the present invention may utilize steps and sequences in addition to, or instead of, certain of the steps and sequences discussed in conjunction with the FIG. 9 embodiment.

In the FIG. 9 embodiment, in step 912, write detector module 224 monitors video memory 216 for write operations by CPU 122 or any other appropriate entity. In step 916, write detector module 224 determines whether a write operation to main window data 612 of on-screen data 312 has occurred by utilizing any effective means. For example, in certain embodiments, write detector module 224 compares a write address from the foregoing write operation with main window start/end addresses from on-screen registers 428 to thereby determine whether a write operation to main window data 612 has occurred. If write detector module 224 determines that a write operation to main window data 612 has occurred, then in step 920, write detector module sets transfer flag 424 in controller registers 220 to indicate that on-screen data 312 has been modified.

However, if write detector module 224 determines that no write operation to main window data 612 has occurred, then in step 924, write detector module 224 determines whether a write operation to PIP data 616 of on-screen data 312 has occurred by utilizing any effective means. For example, in certain embodiments, write detector module 224 compares the write address from the foregoing write operation with PIP window start/end addresses from on-screen registers 428 to thereby determine whether a write operation to PIP data 616 has occurred.

If write detector module 224 determines that a write operation to PIP data 616 has occurred, then in step 928, no operation results from the foregoing write to video memory 216 because the write operation did not occur within on-screen data 312. However, in step 924, if write detector module 224 determines that a write operation to PIP data 612 has occurred, then in step 932, write detector module 224 determines whether a PIP mode is currently enabled in electronic device 110 for displaying a picture-in-picture window on display 134. If write detector module 224 determines that the PIP mode is currently enabled in electronic device 110, then in step 920, write detector module sets transfer flag 424 in controller registers 220 to indicate that on-screen data 312 has been modified. The FIG. 9 process may then terminate.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for handling electronic information, comprising:
a write detector module that detects a write operation to on-screen data in a video memory, said write detector module responsively setting a transfer flag to indicate that said on-screen data has been modified; and
controller logic that initiates a transfer operation for transferring said on-screen data from said video memory to a data destination whenever said transfer flag has been set by said write detector module.

2. The system of claim 1 wherein said controller logic and said write detector module are implemented in a display controller that coordinates said transfer operation.

3. The system of claim 2 wherein said display controller conserves device resources and operating power for a portable electronic device by performing said transfer operation only when said on-screen data has been modified.

4. The system of claim 2 said display controller is implemented as an integrated circuit device that functions as a transparent interface between a central processing unit and a display of said portable electronic device.

5. The system of claim 1 wherein said data destination includes a display for a portable electronic device, said display being implemented as a random-access-memory based liquid-crystal display.

6. The system of claim 5 wherein said portable electronic device is implemented as a portable cellular telephone device.

7. The system of claim 1 wherein said on-screen data is stored at one or more moveable locations in said video memory, said write detector module analyzing said video memory to determine whether said write operation occurs within said one or more moveable locations before setting said transfer flag.

8. The system of claim 1 wherein said write detector module monitors said video memory for said write operation from a central processing unit of a host electronic device.

9. The system of claim 8 wherein said write detector module initially determines that said central processing unit has performed said write operation to store image data into off-screen data or said on-screen data in said video memory.

10. The system of claim 9 wherein said write detector module determines that said central processing unit has performed said write operation to store said image data into said on-screen data in said video memory, said on-screen data including main window data and picture-in-picture data.

11. The system of claim 10 wherein said central processing unit prepares for said write operation by programming on-screen data addresses for said on-screen data, said on-screen addresses being stored in on-screen registers that include a main window start address, a main window end address, a picture-in-picture window start address, and a picture-in-picture window end address.

12. The system of claim 11 wherein said write detector module determines that said write operation has occurred within said on-screen data by comparing a write address for said write operation with said on-screen data addresses from said on-screen registers.

13. The system of claim 12 wherein said write detector module sets said transfer flag when said write address for said write operation is between said main window start address and said main window end address, or when said write address for said write operation is between said picture-in-picture window start address and said picture-in-picture window end address.

14. The system of claim 10 wherein said controller logic detects that said write detector module has set said transfer flag, said controller logic responsively initiating a full frame transfer of said on-screen data from said video memory to said data destination.

15. The system of claim 1 wherein said write detector module initially monitors said video memory to determines whether said write operation has occurred within main window data in said video memory.

16. The system of claim 15 wherein said write detector module sets said transfer flag in controller registers of a display controller whenever said write operation has occurred within said main window data.

17. The system of claim 15 wherein said write detector module monitors said video memory to determine whether said write operation has occurred within picture-in-picture window data in said video memory, said write detector module failing to set said transfer flag to initiate said transfer operation whenever said write operation has not occurred within said main window data or said picture-in-picture data.

18. The system of claim 17 wherein said write detector module determines whether a picture-in-picture mode is currently enabled whenever said write operation has occurred within said picture-in-picture data.

19. The system of claim 18 wherein said write detector module sets said transfer flag in controller registers of a display controller whenever said write operation has occurred within said picture-in-picture data and said picture-in-picture mode is currently enabled.

20. The system of claim 19 wherein said controller logic detects that said write detector module has set said transfer flag, said controller logic responsively initiating a full frame transfer of said on-screen data from said video memory to said data destination, said full frame transfer being automatically performed by an automatic transfer module of said controller logic, said full frame transfer alternately being manually performed by a central processing unit of a host electronic device.

21. A method for handling electronic information, comprising the steps of:
detecting a write operation to on-screen data in a video memory by using a write detector module that responsively sets a transfer flag to indicate that said on-screen data has been modified; and
utilizing controller logic to initiate a transfer operation for transferring said on-screen data from said video memory to a data destination whenever said transfer flag has been set by said write detector module.

22. The method of claim 21 wherein said controller logic and said write detector module are implemented in a display controller that coordinates said transfer operation.

23. The method of claim 22 wherein said display controller conserves device resources and operating power for a portable electronic device by performing said transfer operation only when said on-screen data has been modified.

24. The method of claim 22 said display controller is implemented as an integrated circuit device that functions as a transparent interface between a central processing unit and a display of said portable electronic device.

25. The method of claim 21 wherein said data destination includes a display for a portable electronic device, said display being implemented as a random-access-memory based liquid-crystal display.

26. The method of claim 25 wherein said portable electronic device is implemented as a portable cellular telephone device.

27. The method of claim 21 wherein said on-screen data is stored at one or more moveable locations in said video memory, said write detector module analyzing said video memory to determine whether said write operation occurs within said one or more moveable locations before setting said transfer flag.

28. The method of claim 21 wherein said write detector module monitors said video memory for said write operation from a central processing unit of a host electronic device.

29. The method of claim 28 wherein said write detector module initially determines that said central processing unit has performed said write operation to store image data into off-screen data or said on-screen data in said video memory.

30. The method of claim 29 wherein said write detector module determines that said central processing unit has performed said write operation to store said image data into said on-screen data in said video memory, said on-screen data including main window data and picture-in-picture data.

31. The method of claim 30 wherein said central processing unit prepares for said write operation by programming on-screen data addresses for said on-screen data, said on-screen addresses being stored in on-screen registers that include a main window start address, a main window end address, a picture-in-picture window start address, and a picture-in-picture window end address.

32. The method of claim 31 wherein said write detector module determines that said write operation has occurred within said on-screen data by comparing a write address for said write operation with said on-screen data addresses from said on-screen registers.

33. The method of claim 32 wherein said write detector module sets said transfer flag when said write address for said write operation is between said main window start address and said main window end address, or when said write address for said write operation is between said picture-in-picture window start address and said picture-in-picture window end address.

34. The method of claim 30 wherein said controller logic detects that said write detector module has set said transfer flag, said controller logic responsively initiating a full frame transfer of said on-screen data from said video memory to said data destination.

35. The method of claim 21 wherein said write detector module initially monitors said video memory to determines whether said write operation has occurred within main window data in said video memory.

36. The method of claim 35 wherein said write detector module sets said transfer flag in controller registers of a display controller whenever said write operation has occurred within said main window data.

37. The method of claim 35 wherein said write detector module monitors said video memory to determine whether said write operation has occurred within picture-in-picture window data in said video memory, said write detector module failing to set said transfer flag to initiate said transfer operation whenever said write operation has not occurred within said main window data or said picture-in-picture data.

38. The method of claim 37 wherein said write detector module determines whether a picture-in-picture mode is currently enabled whenever said write operation has occurred within said picture-in-picture data.

39. The method of claim 38 wherein said write detector module sets said transfer flag in controller registers of a display controller whenever said write operation has occurred within said picture-in-picture data and said picture-in-picture mode is currently enabled.

40. The method of claim 39 wherein said controller logic detects that said write detector module has set said transfer flag, said controller logic responsively initiating a full frame transfer of said on-screen data from said video memory to said data destination, said full frame transfer being automatically performed by an automatic transfer module of said controller logic, said full frame transfer alternately being manually performed by a central processing unit of a host electronic device.

41. A system for handling electronic information, comprising:
means for detecting a write operation to on-screen data in a video memory;
means for responsively setting a transfer flag to indicate that said on-screen data has been modified; and
means for initiating a transfer operation for transferring said on-screen data from said video memory to a data destination whenever said transfer flag has been set.

42. A system for handling electronic information, comprising:
a write detector module that detects a write operation to a device memory, said write detector module responsively setting a transfer flag to indicate that said device memory has been modified; and
controller logic that initiates a transfer operation for transferring data from said device memory to a data destination whenever said transfer flag has been set by said write detector module.
